(19) United States
(12) Patent Application Publication
(10) Pub. No.: US 2025/0024144 A1
(43) Pub. Date: Jan. 16, 2025

(54) IN CABIN MONITORING SYSTEMS AND PROCESSES

(71) Applicant: Gentex Corporation, Zeeland, MI (US)

(72) Inventor: Keith H. Berends, Hudsonville, MI (US)

(73) Assignee: Gentex Corporation, Zeeland, MI (US)

(21) Appl. No.: 18/767,020

(22) Filed: Jul. 9, 2024

Related U.S. Application Data
(60) Provisional application No. 63/525,992, filed on Jul. 11, 2023.

(51) Int. Cl. H04N 23/667; G06V 20/59; H04N 23/71; H04N 23/75

(52) U.S. Cl. CPC H04N 23/667; G06V 20/597; H04N 23/71; H04N 23/75

(57) ABSTRACT

A monitoring system includes an imaging module that captures image data associated with a vehicle cabin and an electro-optic assembly configured to switch transmission states upon an applied voltage. A control system is in communication with the imaging module and the electro-optic assembly. The control system is configured to receive the image data from the imaging module and detect a presence of light value in the image data that exceeds a threshold value and is proximate the eyes of a vehicle occupant and determine an origin of the presence of light value through the electro-optic assembly by detecting a presence of a shadow in proximity to the eyes of the vehicle occupant. The control system applies a voltage to reduce transmission of the electro-optic assembly and lower the presence of light directed towards the eyes of the vehicle occupant to a value below the predetermined threshold value.

### CROSS-REFERENCE TO RELATED APPLICATION

This application claims priority to and the benefit under 35 U.S.C. § 119 (e) of U.S. Provisional Application No. 63/525,992, filed on Jul. 11, 2023, entitled “IN CABIN MONITORING SYSTEMS AND PROCESSES,” the disclosure of which is hereby incorporated herein by reference in its entirety.

### FIELD OF THE DISCLOSURE

The present disclosure generally relates to a monitoring system for a vehicle, and, more particularly, a monitoring system for a cabin of a vehicle and subsequent processes.

### SUMMARY OF THE DISCLOSURE

According to an aspect of the present disclosure, a monitoring system includes an imaging module that captures image data associated with a vehicle cabin and an electro-optic assembly configured to switch transmission states upon an applied voltage. A control system is in communication with the imaging module and the electro-optic assembly. The control system is configured to receive the image data from the imaging module and detect a presence of light value in the image data that exceeds a threshold value and is proximate to the eyes of a vehicle occupant and determine an origin of the presence of light value through the electro-optic assembly by detecting a presence of a shadow in proximity to the eyes of the vehicle occupant. The control system applies a voltage to reduce transmission of the electro-optic assembly and lower the presence of light directed towards the eyes of the vehicle occupant to a value below the predetermined threshold value.

According to another aspect of the present disclosure, a monitoring system includes an imaging module configured to capture image data associated with a vehicle cabin. A control system is in communication with the imaging module. The control system is configured to receive the image data from the imaging module at least one eye of a vehicle occupant and determine a pupil-to-iris ratio with the image data. The control system is further configured to determine at least one of a presence of light value in the image data that exceeds a predetermined threshold value and is proximate the at least one eye or a presence of a medical condition by comparing the pupil-to-iris ratio with a healthy pupil-to-iris ratio model.

According to still another an aspect of the present disclosure, a monitoring system includes an imaging module that captures image data associated with a vehicle cabin and an electro-optic assembly configured to switch transmission states upon an applied voltage. A control system is in communication with the imaging module and the electro-optic assembly. The control system is configured to receive the image data from the imaging module and detect a presence of light value in the image data that exceeds a threshold value and is proximate to the eyes of a vehicle occupant or an iris-to-pupil ratio associated with the presence of light value exceeding the predetermined threshold value. The control system further determines an origin of the presence of light value through the electro-optic assembly by detecting a presence of a shadow in proximity to the eyes of the vehicle occupant. The control system applies a voltage to reduce transmission of the electro-optic assembly and lower the presence of light directed towards the eyes of the vehicle occupant to a value below the predetermined threshold value.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is an interior perspective view of a cabin in a vehicle with a monitoring system, in accordance with an aspect of the present disclosure;

FIG. 2 is a side cross-sectional view of an electro-optic assembly of a monitoring system, in accordance with an aspect of the present disclosure;

FIG. 3 is a schematic view of a monitoring system, in accordance with an aspect of the present disclosure;

FIG. 4 is a view of image data captured by an imaging capturing module of a monitoring system, in accordance with an aspect of the present disclosure;

FIG. 5 is a view of image data captured by an imaging capturing module of a monitoring system, in accordance with an aspect of the present disclosure; and

FIG. 6 is a schematic view of a control system that controls functionalities of a monitoring system in accordance with an aspect of the present disclosure.

### DETAILED DESCRIPTION

The present illustrated embodiments reside primarily in combinations of method steps and apparatus components related to a monitoring system for a cabin of a vehicle and subsequent processes. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

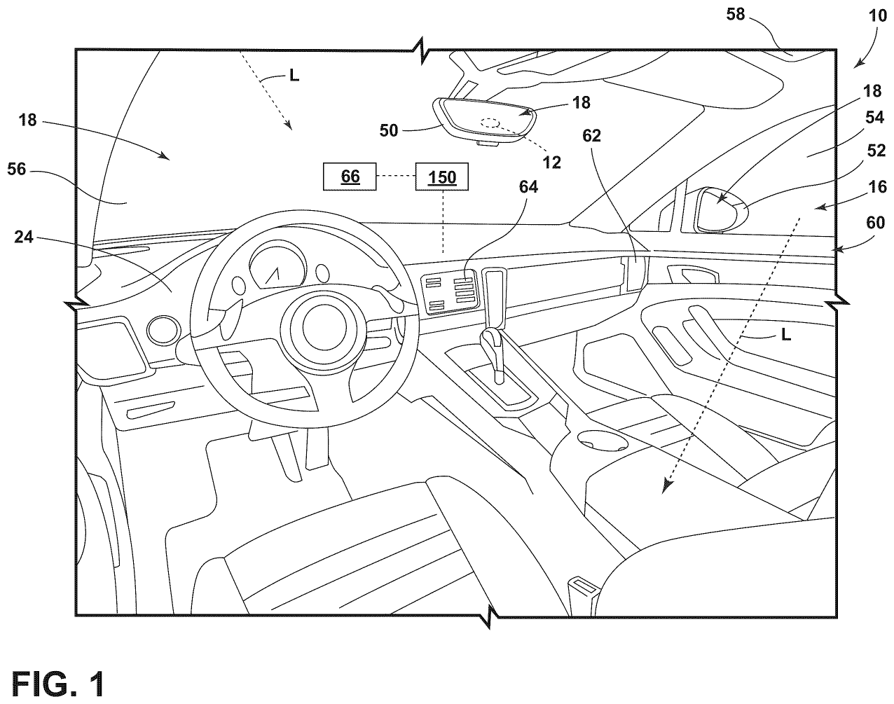

For purposes of description herein, the terms “upper,” “lower,” “right,” “left,” “rear,” “front,” “vertical,” “horizontal,” and derivatives thereof, shall relate to the disclosure as oriented in FIG. 1. Unless stated otherwise, the term “front” shall refer to the surface of the device closer to an intended viewer of the device, and the term “rear” shall refer to the surface of the device further from the intended viewer of the device. However, it is to be understood that the disclosure may assume various alternative orientations, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

Referring initially to FIGS. 1-3, reference numeral 10 generally designates a monitoring system. The monitoring system 10 includes an imaging module 12 configured to capture image data 14 associated with a vehicle cabin 16 and an electro-optic assembly 18 configured to switch transmission states upon an applied voltage. A control system 100 (e.g., a processor 104) is in communication with the imaging module 12 and the electro-optic assembly 18. The control system 100 is configured to receive the image data 14 from the imaging module 12 and determine a presence of light value “L” in the image data 14 that exceeds a threshold value and is associated with a region of the eyes of a vehicle occupant 20. The control system 100 is further configured to apply a voltage to reduce transmission of the electro-optic assembly 18 and lower the presence of the light value L directed towards the eyes of a vehicle occupant 20 below the predetermined threshold value.

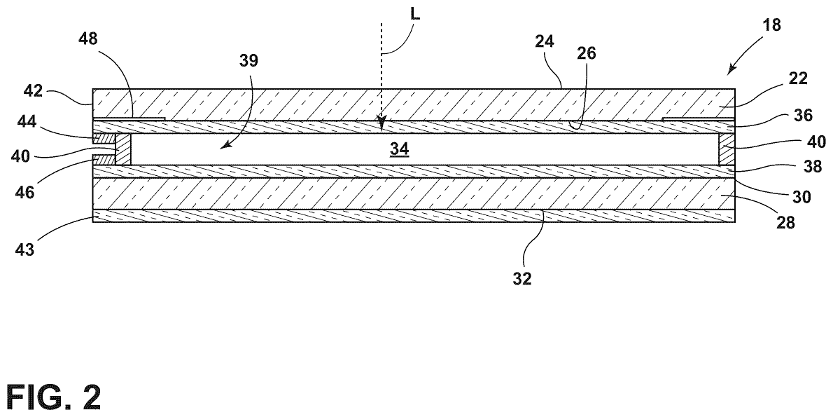

With reference now to FIGS. 1-2, the electro-optic assembly 18 may be a single-layer component, a single-phase component, a multi-layer component, and/or a multi-phase component that can be switched between the partially transmissive state (i.e., that blocks a portion of the light L) and the fully (e.g., substantially full) transmissive state. In some embodiments, the electro-optic assembly 18 may include and/or be coupled to a transreflective layer. In this manner, the partially transmissive state may be further referred to as a reflective state, such that the light L is blocked by reflection from the electro-optic assembly 18 (e.g., the transreflective layer). The electro-optic assembly 18 includes a first substrate 22 that has a first surface 24 and a second surface 26 opposite the first surface 24. A second substrate 28 has a third surface 30 and a fourth surface 32 opposite the third surface 30. The second and third surfaces 26, 30 face each other to define a gap 34. A first electrode 36 is coupled to the second surface 26, and a second electrode 38 is coupled to the third surface 30. An electro-optic medium 39 is located between the first electrode 36 and the second electrode 38. The electro-optic medium 39 may be retained within the gap 34 via a seal 40 that extends along a perimeter 42 of the electro-optic assembly 18. In some embodiments, the transreflective layer may be located on the third surface 30, the fourth surface 32, behind the fourth surface 32, and/or behind the electro-optic medium 39. In some embodiments, a display module 43 may be located behind the fourth surface 32 that is configured to generate graphics, reproduce images from the image capturing module 12, generate maps, video calls, and/or the like.

The first electrode 36 and the second electrode 38 may be formed by electrically conductive transparent materials, including, but not limited to, a transparent conducting film (e.g., indium tin oxide (ITO), F:SnO2, ZnO, IZO), insulator/metal/insulator stack “IMI Structures”, carbon (graphene and/or graphite), and/or a conductive metal mesh (e.g., nanowires). In various examples, the electro-optic medium 39 may include at least one solvent, at least one anodic material, and at least one cathodic material. Typically, both of the anodic and cathodic materials are electroactive and at least one of them may be electrochromic. It will be understood that regardless of its ordinary meaning, the term “electroactive” may mean a material that undergoes a modification in its oxidation state upon exposure to a particular electrical potential difference. Additionally, it will be understood that the term “electrochromic” may mean, regardless of its ordinary meaning, a material that exhibits a change in its extinction coefficient at one or more wavelengths upon exposure to a particular electrical potential difference.

Referring still to FIGS. 1 and 2, a first electrical bus 44 may be coupled to (i.e., in conductive communication with) to the first electrode 36 and a second electrical bus 46 may be connected to the second electrode 38. The electric buses 44, 46 may include a conductive adhesive, tape, and/or the like, that may include a higher electric conductivity than one of or both of the first electrode 36 and the second electrode 38. In this manner, the electrical buses 44, 46 may provide current to the electrodes 36, 38. The electric buses 44, 46 may be placed on an internal surface (e.g., a surface that faces towards the gap 34) of the first electrode 36 and/or the second electrode 38 or the buses 44, 46 may be placed on an outer surface (e.g., a surface that faces away from the gap 34) of the first electrode 36 and/or the second electrode 38. In some instances, the buses 44, 46 may transverse an entire perimeter of the gap 34 or may be localized to one or more discrete locations. The electro-optic assembly 18 also has a front side (e.g., corresponding with the first surface 24) that may be referred to as a “viewing side,” that is closest to a vehicle occupant 20. A border of the electro-optic assembly 18 may incorporate a concealing layer 48 or edge treatment, such as a chrome ring, a glass frit, an opaque ring, or other similar finish, to conceal components behind the first substrate 22.

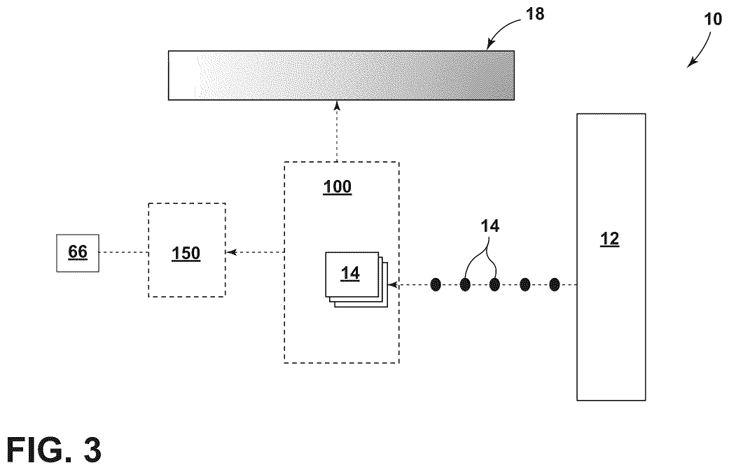

With reference now to FIG. 3, the image capturing module 12 may be located in a variety of positions within (e.g., ceiling, vehicle pillars, and/or the like) or outside of a vehicle associated with the monitoring system 10. In some examples, the image capturing module 12 may be located on a rear side (e.g., behind) of the electro-optic assembly 18 (e.g., on a side of the electro-optic assembly 18 opposite of the occupant's location). The image capturing module 12 may be configured to capture 2D information in the image data 14 in a visible light spectrum, an infrared spectrum, and/or a near-infrared spectrum. In some embodiments, the image capturing module 12 may be configured to capture 3D information under the principles of structured light, stereovision, and/or light detection and ranging (“LiDAR”). In this manner, the image capturing module 12 may work in conjunction with one or more light sources that produce flood illumination, structured light patterns, and/or the like in one or more of the visible light spectrum, the infrared spectrum, and/or the near-infrared spectrum. In some embodiments, the control system 100 (e.g., the processor 104) may be configured to extrapolate the 2D information to obtain the 3D information. In some embodiments, the 3D information can be utilized to determine the absolute scale within the vehicle cabin 16.

With reference back now to FIG. 1, the electro-optic assembly 18 may be incorporated into a variety of structures. For example, the electro-optic assembly 18 may be configured as an electro-chromic device that includes the transreflective layer behind the electro-optic medium 39 such that it can be switched between the transmissive state (i.e., reflective) and the partially transmissive state (or, alternatively a fully opaque state). In such configurations, the electro-optic assembly 18 may be incorporated into a rearview mirror device 50 or a side mirror 52 (e.g., passenger or driver's side). In some embodiments, the electro-optic assembly 18 may be configured to be switched between the transmissive state (i.e., clear) and the partially transmissive state (or, alternatively a fully opaque state). In such configurations, the electro-optic assembly 18 may be incorporated into a side window 54, a front/rear window 56, and/or a sunroof window 58. In additional embodiments, the electro-optic assembly 18 may include a plurality of electro-optic assemblies 18 provided in combinations of the variety of structures. In some embodiments, the image capturing module 12 may be located in a common housing with the electro-optic assembly 18 (e.g., the rearview mirror device 50 or the side mirror 52). The control system 100 may be configured to triangulate a location of a light source (e.g., the sun, headlights of other vehicles, and/or other environmental lighting) from which the presence of the light L originates. In this manner, the monitoring system 10 may effectively reduce the transmission of the mirror 50, 52 to reduce glare and/or reduce the transmission of a window 54, 56, 58 to reduce the amount of light L directed to the eyes of a vehicle occupant 20 for an improved vehicle occupant 20 experience. The term vehicle occupant 20 may refer to an operator or driver of the vehicle, a front passenger, and/or a rear passenger.

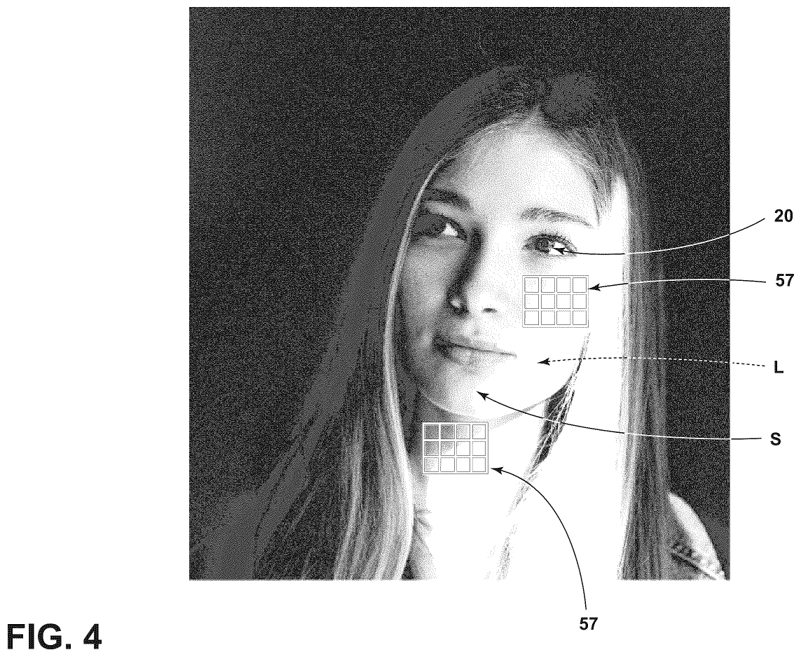

With reference to FIG. 4, in some embodiments, the control system 100 (e.g., the processor 104) is configured to determine the presence of light value L in the image data 14 by determining a presence of a shadow “S” in a region (e.g., proximate and/or overlapping) relationship relative to, for example, the eyes of a vehicle occupant 20. The control system 100 may be configured to develop a digital grid 57 and/or another form of matrix or shape (e.g., an array that is symmetrical or unsymmetrical) over the image data 14. As depicted, the digital grid 57 may include rows and columns with square-shaped cells. The digital grid 57 may be utilized to map a perimeter of and/or border between the shadow S and the presence of light value L. In this manner, the control system 100 may utilize the digital grid 57 to measure the perimeter of the shadow S relative to the presence of light L to triangulate the location of the light source (e.g., the section or portion of the electro-optic assembly 18 that the presence of the light L transmits through) and apply an appropriate voltage to the electro-optic assembly 18 (e.g., one or more electro-optic assemblies 18 of several) to a selected level of transmission. In some embodiments, the electro-optic assembly 18 may be segmented. More particularly, the first and second electrodes 36, 38 may include conductively isolated segmentations to selectively change the transmissiveness to only certain regions of the electro-optic assembly 18 corresponding to one or more segmentations. For example, the control system 100 may be configured to darken segmentations associated with the presence and origin of the light entering the window 54, 56, 58 or reflecting from the mirror 50, 52.

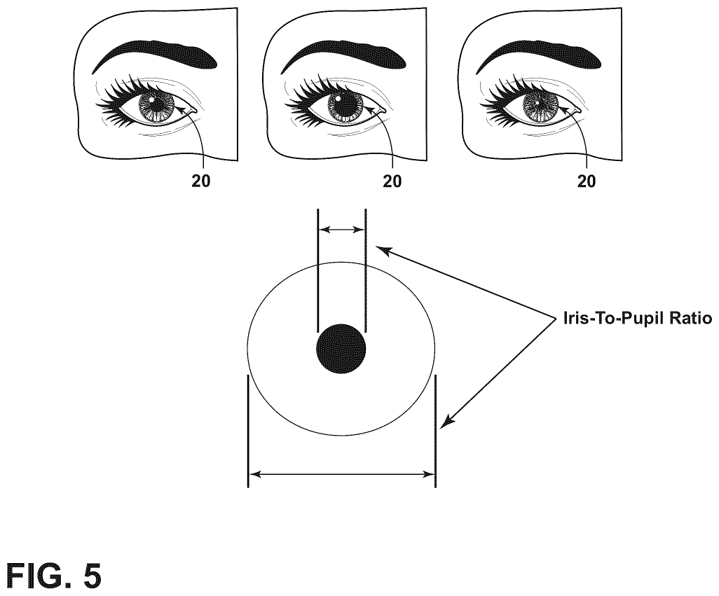

With reference now to FIG. 5, in some embodiments, the control system 100 (e.g., the processor 104) is configured to determine the presence of light value L in the image data 14 by monitoring changes to the eyes of a vehicle occupant 20. For example, the control system 100 may review image data 14 to determine a baseline pupil-to-iris ratio and continually monitor the baseline pupil-to-iris ratio (e.g., in subsequent images) for a changing (e.g., decreasing) size of the pupil beyond a threshold value. More particularly, as an eye is exposed to the presence of light value L, the pupil will become smaller thus increasing the pupil-to-iris ratio. In such scenarios, the control system 100 may generate a signal to apply the voltage and reduce transmission of the electro-optic assembly 18. In addition or alternatively to reducing transmission of the electro-optic assembly 18, the monitoring system 10 may be configured to review image data 14 of the eyes of a vehicle occupant 20 for other important visual ques related to driver health. For example, irregularities in the baseline pupil-to-iris ratio and/or a manner in which the pupil-to-iris ratio changes over time (e.g., after exposure to the light L) can be detected. More particularly, a dilation, constriction, or unequally sized pupils can be an indication of a medical condition. In this manner, and as will be described in greater detail below, the control system 100 may utilize template profiles and/or extract and construct profiles (e.g., via machine learning) of healthy and/or unhealthy pupil-to-iris ratios that can be compared to the baseline pupil-to-iris ratio or the detected pupil-to-iris ratio (e.g., changes to the pupil-to-iris ratio). In some embodiments, the control system 100 may be configured to generate a notification to the vehicle occupant if a medical condition is detected. The notification may be visual, audible, or combination thereof. The notification may be local (e.g., on the display module 43) or transmitted to one or more devices or centers (e.g., a personal device such as a cell phone, a center such as an emergency medical center, a central vehicle fleet command center, combinations thereof, and/or the like). It should also be appreciated that in some embodiments, the medical condition (e.g., the template profiles and/or learned profiles) may be associated with intoxication from a controlled substance.

With reference now to FIGS. 1-5, the monitoring system 10 may be utilized for other functionalities. More particularly, the control system 100 may be in operable communication with one or more components of a vehicle 60, such as a climate control system 62, dashboard brightness control system 64, a global positioning system 66 (“GPS”) and/or the like. For example, the control system 100 (e.g., the processor 104) may be configured to generate a signal based the presence of light value L to the climate control system 62 to modify a temperature within the vehicle cabin 16. More particularly, upon a determination of the presence of light value L above the threshold value, the control system 100 (e.g., the processor 104) may generate a signal to the climate control system 62 to reduce a temperature within the vehicle cabin 16. In some embodiments, the signal may include instructions to modify the temperature only in a localized region (e.g., a driver's side or passenger's side) that is exposed to the light L. In another example, the control system 100 (e.g., the processor 104) may be configured to generate a signal based the presence of light value L to the dashboard brightness control system 64 to modify a brightness level of a dashboard control. More particularly, upon a determination of the presence of light value L above the threshold value, the control system 100 (e.g., the processor 104) may generate a signal to the dashboard brightness control system 64 to increase the brightness level to improve visibility. In some embodiments, the control system 100 may be in operable communication with the GPS 66 and may utilize weather patterns and/or sun patterns for a particular location to at least in part, determine a direction (e.g., the location of the light source) from the detected presence of light value L and the origin of the light source (e.g., light from the sun) the location of the light source.

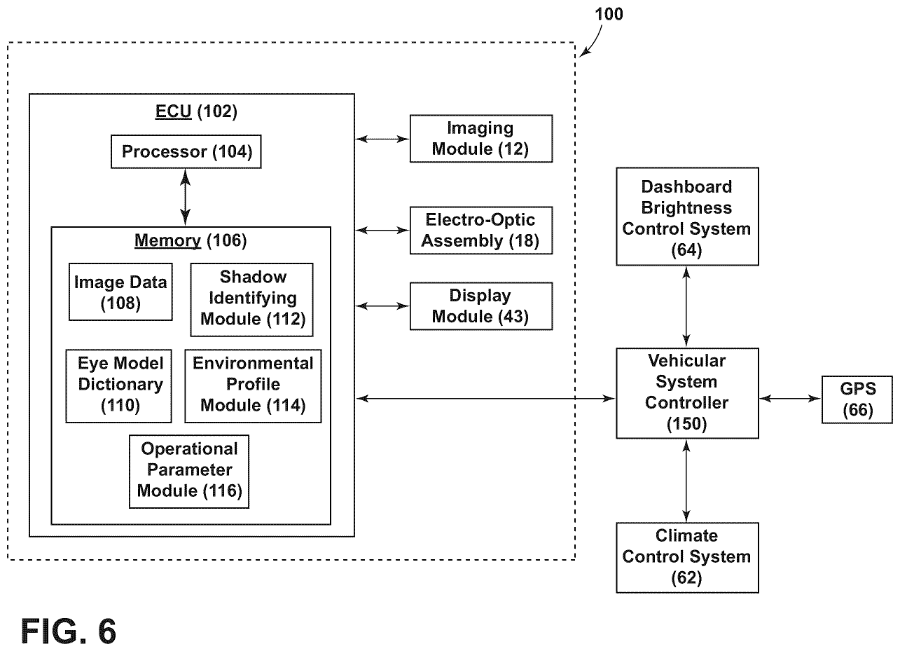

With reference now to FIG. 6, the control system 100 of the monitoring system 10 may include at least one electronic control unit (ECU) 102. The at least one ECU 102 may be located in rearview mirror device 50 and/or other structures in the vehicle 60. In some embodiments, components of the ECU 102 are located in both the rearview mirror device 50 and other structures in the vehicle 60. The at least one ECU 102 may include the processor 104 and a memory 106. The processor 104 may include any suitable processor 104. Additionally, or alternatively, each ECU 102 may include any suitable number of processors, in addition to or other than the processor 104. The memory 106 may comprise a single disk or a plurality of disks (e.g., hard drives) and includes a storage management module that manages one or more partitions within the memory 106. In some embodiments, memory 106 may include flash memory, semiconductor (solid state) memory, or the like. The memory 106 may include Random Access Memory (RAM), a Read-Only Memory (ROM), Electrically Erasable Programmable Read-Only Memory (EEPROM), or a combination thereof. The memory 106 may include instructions that, when executed by the processor 104, cause the processor 104 to, at least, perform the functions associated with the components of the monitoring system 10. The imaging module 12, the electro-optic assembly 18, the display module 43, the climate control system 62, the dashboard brightness control system 64, and the global positioning system 66 may, therefore, be controlled by, receive signals, and/or transmit signals to the control system 100. The memory 106 may, therefore, include image data 108 (e.g., one or more of a series of image data 14 captured from the imaging module 12), an eye model dictionary 110 (e.g., profiles of healthy and/or unhealthy pupil-to-iris ratios), a shadow identifying module 112, an environmental profile module 114 (e.g., sun patterns and/or weather patterns), and an operational parameter module 116 (e.g., an applied voltage to transmission state conversion). The vehicle 60 may also include one or more vehicular system controllers 150 communicating with the control system 100 to control features such as the climate control system 62, the dashboard brightness control system 64, and the global positioning system 66.

The image data 108 may include one or more of a series of image data 14 captured from the imaging module 12 that is reviewed by the control system 100 to detect the presence of an occupant, the eyes of a vehicle occupant 20, the presence of shadows S, and the presence of light. The eye model dictionary 110 may include instructions for detecting a location the eyes of a vehicle occupant 20 and may include instructions to measure the size of the eyes of a vehicle occupant 20, gaze direction, and/or the like. The eye model dictionary 110 may include the template profiles and/or extract and construct profiles (e.g., via machine learning) of healthy and/or unhealthy pupil-to-iris ratios that can be compared to the baseline pupil-to-iris ratio or the detected pupil-to-iris ratio (e.g., changes to the pupil-to-iris ratio). The shadow identifying module 112 may include instructions for detecting shadows S in the image data 108. The instructions may further include detecting, measuring, and reviewing brightness within the image data 108 including the reduced brightness in the shadow S and the increased brightness from the presence of light value L.

The shadow identifying module 112 may further include instructions for triangulating the location of the light source (e.g., the section or portion of the electro-optic assembly 18 that the presence of the light L transmits through) and generating a signal to apply an appropriate voltage to the electro-optic assembly 18 (e.g., one or more electro-optic assemblies 18 of several or segments of the electro-optic assembly 18) to a selected level of transmission to reduce the brightness value. The environmental profile module 114 may be in communication with the GPS 66 and determine or otherwise receive sun patterns, weather patterns, etc. In some embodiments, the environmental profile module 114 may classify the light as natural (e.g., via the sun), from other vehicles, or from other light sources within the environment. For example, rapid changes in the relative positioning between the shadow S and the presence of the light L may indicate a moving vehicle as the origin of the light whereas slower changes in the relative positioning between the shadow S and the presence of the light value L may indicate the sun as the origin of light. The operational parameter module 116 may include instructions, based on the detected presence of light and the measured presence of light value L, and a location of the origin of light and where it enters into the vehicle (e.g., through the electro-optic assembly 18) to generate a signal to modify an applied voltage to one or more electro-optic assemblies 18 and/or one or more segments of the one or more electro-optic assemblies 18.

The disclosure is further summarized in the following paragraphs and is further characterized by combinations of any and all of the various aspects described therein.

According to an aspect of the present disclosure, a monitoring system includes an imaging module that captures image data associated with a vehicle cabin and an electro-optic assembly configured to switch transmission states upon an applied voltage. A control system is in communication with the imaging module and the electro-optic assembly. The control system is configured to receive the image data from the imaging module and detect a presence of light value in the image data that exceeds a threshold value and is proximate to the eyes of a vehicle occupant and determine an origin of the presence of light value through the electro-optic assembly by detecting a presence of a shadow in proximity to the eyes of the vehicle occupant. The control system applies a voltage to reduce transmission of the electro-optic assembly and lower the presence of light directed towards the eyes of the vehicle occupant to a value below the predetermined threshold value.

According to yet another aspect, a control system is further configured to determine a presence of a shadow by developing a digital grid over an image data and mapping a perimeter of the shadow.

According to still yet another aspect, a control system is further configured to triangulate a light source from which a presence of a light originates.

According to another aspect, a control system is further configured to detect a presence of light value in an image data by determining a baseline pupil-to-iris ratio and monitoring a baseline pupil-to-iris ratio for a decreasing size of a pupil beyond a threshold value.

According to yet another aspect, a control system is further configured to determine a presence of a medical condition by comparing a baseline pupil-to-iris ratio with a healthy pupil-to-iris ratio model.

According to another aspect, an electro-optic assembly includes a plurality of conductively isolated segmentations.

According to still another aspect, a control system is configured to determine which of the plurality of conductively isolated segmentations are associated with an origin of a presence of light value and selectively apply a voltage to only the conductively isolated segmentations associated with the origin of the presence of light value.

According to another aspect of the present disclosure, a monitoring system includes an imaging module configured to capture image data associated with a vehicle cabin. A control system is in communication with the imaging module. The control system is configured to receive the image data from the imaging module at least one eye of a vehicle occupant and determine a pupil-to-iris ratio with the image data. The control system is further configured to determine at least one of a presence of light value in the image data that exceeds a predetermined threshold value and is proximate the at least one eye or a presence of a medical condition by comparing the pupil-to-iris ratio with a healthy pupil-to-iris ratio model.

According to another aspect, a control system is configured to determine a presence of a medical condition by comparing the pupil-to-iris ratio with a healthy pupil-to-iris ratio model.

According to yet another aspect, a control system is further configured to, upon determination of a presence of a medical condition, generate a notification.

According to still another aspect, the notification is transmitted to at least one of an emergency medical center and a central vehicle fleet command center.

According to another aspect, the medical condition is associated with intoxication.

According to yet another aspect, a control system is configured to determine a presence of light value in the image data that exceeds a threshold value and is proximate the at least one eye based on changes to a pupil-to-iris ratio.

According to still another aspect, an electro-optic assembly configured to switch transmission states upon an applied voltage.

According to another aspect, a control system is further configured to apply a voltage to reduce transmission of an electro-optic assembly and lower a presence of light value directed towards the at least one eye of the vehicle occupant to a value below the predetermined threshold value.

According to yet another aspect, an electro-optic assembly includes a plurality of conductively isolated segmentations.

According to still another aspect of the present disclosure, a monitoring system includes an imaging module that captures image data associated with a vehicle cabin and an electro-optic assembly configured to switch transmission states upon an applied voltage. A control system is in communication with the imaging module and the electro-optic assembly. The control system is configured to receive the image data from the imaging module and detect a presence of light value in the image data that exceeds a threshold value and is proximate the eyes of a vehicle occupant or an iris-to-pupil ratio associated with the presence of light value exceeding the predetermined threshold value. The control system further determines an origin of the presence of light value through the electro-optic assembly by detecting a presence of a shadow in proximity to the eyes of the vehicle occupant. The control system applies a voltage to reduce transmission of the electro-optic assembly and lower the presence of light directed towards the eyes of the vehicle occupant to a value below the predetermined threshold value.

According to another aspect, a control system is configured to determine the origin of the presence of light value through the electro-optic assembly by developing a digital grid over the image data, mapping a perimeter of the shadow, and triangulating a light source from which the presence of the light originates.

According to yet another aspect, a control system is configured to detect the presence of light value in the image data by determining a baseline pupil-to-iris ratio and monitoring the baseline pupil-to-iris ratio for a decreasing size of the pupil beyond a threshold value.

According to still another aspect, a control system is further configured to determine a presence of a medical condition by comparing the baseline pupil-to-iris ratio with a healthy pupil-to-iris ratio model.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

It is also important to note that the construction and arrangement of the elements of the disclosure, as shown in the exemplary embodiments, is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures and/or members or connectors or other elements of the system may be varied, and the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

It is also to be understood that variations and modifications can be made on the aforementioned structures and methods without departing from the concepts of the present disclosure, and further it is to be understood that such concepts are intended to be covered by the following claims unless these claims by their language expressly state otherwise.

What is claimed is:

1. A monitoring system, comprising:
an imaging module configured to capture image data associated with a vehicle cabin;
an electro-optic assembly configured to switch transmission states upon an applied voltage; and
a control system in communication with the imaging module and the electro-optic assembly, the control system configured to:
receive the image data from the imaging module;
detect a presence of light value in the image data that exceeds a predetermined threshold value and is proximate eyes of a vehicle occupant;
determine an origin of the presence of light value through the electro-optic assembly by detecting a presence of a shadow in proximity to the eyes of the vehicle occupant; and
apply a voltage to reduce transmission of the electro-optic assembly and lower the presence of light value directed towards the eyes of the vehicle occupant to a value below the predetermined threshold value.

2. The monitoring system of claim 1, wherein the control system is further configured to determine the presence of the shadow by:
developing a digital grid over the image data; and
mapping a perimeter of the shadow.

3. The monitoring system of claim 2, wherein the control system is further configured to triangulate a light source from which the presence of the light originates.

4. The monitoring system of claim 1, wherein the control system is further configured to detect the presence of light value in the image data by:
determining a baseline pupil-to-iris ratio; and
monitoring the baseline pupil-to-iris ratio for a decreasing size of the pupil beyond a threshold value.

5. The monitoring system of claim 4, wherein the control system is further configured to determine a presence of a medical condition by comparing the baseline pupil-to-iris ratio with a healthy pupil-to-iris ratio model.

6. The monitoring system of claim 1, wherein the electro-optic assembly includes a plurality of conductively isolated segmentations.

7. The monitoring system of claim 6, wherein the control system is further configured to:
determine which of the plurality of conductively isolated segmentations are associated with the origin of the presence of light value; and
selectively apply a voltage to only the conductively isolated segmentations associated with the origin of the presence of light value.

8. A monitoring system, comprising:
an imaging module configured to capture image data associated with a vehicle cabin; and
a control system in communication with the imaging module, the control system configured to:
receive the image data from the imaging module of at least one eye of a vehicle occupant;
determine a pupil-to-iris ratio with the image data; and
determine at least one of a presence of light value in the image data that exceeds a predetermined threshold value and is proximate the at least one eye or a presence of a medical condition by comparing the pupil-to-iris ratio with a healthy pupil-to-iris ratio model.

9. The monitoring system of claim 8, wherein the control system is configured to determine the presence of a medical condition by comparing the pupil-to-iris ratio with the healthy pupil-to-iris ratio model.

10. The monitoring system of claim 9, wherein the control system is further configured to, upon determination of the presence of a medical condition, generate a notification.

11. The monitoring system of claim 10, wherein the notification is transmitted to at least one of an emergency medical center and a central vehicle fleet command center.

12. The monitoring system of claim 10, wherein the medical condition is associated with intoxication.

13. The monitoring system of claim 8, wherein the control system is configured to determine the presence of light value in the image data that exceeds the threshold value and is proximate the at least one eye based on changes to the pupil-to-iris ratio.

14. The monitoring system of claim 13, further including an electro-optic assembly configured to switch transmission states upon an applied voltage.

15. The monitoring system of claim 14, wherein the control system is further configured to apply a voltage to reduce transmission of the electro-optic assembly and lower the presence of light value directed towards the at least one eye of the vehicle occupant to a value below the predetermined threshold value.

16. The monitoring system of claim 15, wherein the electro-optic assembly includes a plurality of conductively isolated segmentations.

17. A monitoring system, comprising:
a rearview mirror assembly including a display module;
an imaging module configured to capture image data associated with a vehicle cabin;
an electro-optic assembly configured to switch transmission states upon an applied voltage; and
a control system in communication with the imaging module and the electro-optic assembly, the control system configured to:
receive the image data from the imaging module;
detect a presence of light value in the image data that exceeds a predetermined threshold value that is proximate eyes of a vehicle occupant or an iris-to-pupil ratio associated with the presence of light value exceeding the predetermined threshold value;
determine an origin of the presence of light value through the electro-optic assembly by detecting a presence of a shadow in proximity to the eyes of the vehicle occupant; and
apply a voltage to reduce transmission of the electro-optic assembly and lower the presence of light value directed towards the eyes of the vehicle occupant to a value below the predetermined threshold value.

18. The monitoring system of claim 17, wherein the control system is further configured to determine the origin of the presence of light value through the electro-optic assembly by:
developing a digital grid over the image data;
mapping a perimeter of the shadow; and
triangulating a light source from which the presence of the light originates.

19. The monitoring system of claim 17, wherein the control system is further configured to detect the presence of light value in the image data by:
determining a baseline pupil-to-iris ratio; and
monitoring the baseline pupil-to-iris ratio for a decreasing size of the pupil beyond a threshold value.

20. The monitoring system of claim 19, wherein the control system is further configured to determine a presence of a medical condition by comparing the baseline pupil-to-iris ratio with a healthy pupil-to-iris ratio model.
